(19) United States
(12) Patent Application Publication
(10) Pub. No.: US 2007/0069040 A1
(43) Pub. Date: Mar. 29, 2007

(54) Apparatus and methods for dispensing fluidic or viscous materials

(76) Inventors: Russell H. Lewis, Rancho Santa Fe, CA (US); Mihai A. Solomon, San Diego, CA (US)

Correspondence Address: GAZDZINSKI & ASSOCIATES, 11440 WEST BERNARDO COURT, SUITE 375, SAN DIEGO, CA, 92127, US

(21) Appl. No.: 11/504,136

(22) Filed: Aug. 14, 2006

Related U.S. Application Data
(60) Provisional application No. 60/708,821, filed on Aug. 15, 2005.

(51) Int. Cl. A62C 5/02; B05B 1/28; A62C 31/02; F23D 11/16; B05B 7/06

(52) U.S. Cl. 239/8; 239/290; 239/296; 239/390; 239/397; 239/420; 239/424

(57) ABSTRACT

A dispensing apparatus and methods for use with, e.g., a multi-component reactive material process. In one embodiment, the apparatus comprises a completely disposable static mixer, manifold and atomizer cap assembly. Such a configuration allows for, inter alia, reduced cost, rapid component changes with minimal material waste, as well as reducing or eliminating the use of hazardous solvents. Precise and repeatable configuration of the dispensing assembly is also provided by way of the substantially fixed relationship of the critical components and surfaces therein.

### PRIORITY

This application claims priority to co-pending U.S. provisional patent application Ser. No. 60/708,821 of the same title filed Aug. 15, 2005, incorporated herein by reference in its entirety.

### COPYRIGHT

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### FIELD OF THE INVENTION

The present invention relates generally to the field of plural-component coating applications, and in one exemplary aspect to apparatus and methods for delivering fluidic and/or viscous materials.

### DESCRIPTION OF RELATED TECHNOLOGY

A variety of different techniques for delivering and/or spraying fluid and/or viscous components (such as reactive polymers used in applying coatings) are known in the prior art. For example, U.S. Pat. No. 4,019,653 to Scherer, et al. issued Apr. 26, 1977 entitled “Automatic proportioning paint spray system” discloses apparatus for spraying paints wherein the paint comprises a predetermined ratio mixture of at least two components, and wherein the ratio of these components is controlled automatically as they are delivered to a spray gun and prior to mixing, by means flow-sensing devices which generate flow-representative signals to a control unit. The control unit calculates the appropriate ratio and adjusts a flow regulating device in at least one of the component lines for ensuring continued flow at the desired ratio.

U.S. Pat. No. 4,171,096 to Welsh, et al. issued Oct. 16, 1979 entitled “Spray gun nozzle attachment” discloses a nozzle for a spray gun for depositing liquid on a work surface including a body having a channel communicating with a dispensing tip for the liquid, an assembly for attaching the body to the spray gun such that the liquid supplied from the spray gun is introduced into the channel of the body, a passage for the transmittal of pressurized air from the spray gun to a position proximate the dispensing tip, and an air cap circumposed about the dispensing tip having a plurality of orifices therein communicating with the passage for directing pressurized air jets axially of the air cap, whereby the liquid emitted from the dispensing tip is entrained within the confines of the pressurized air jets and deposited on the work surface.

U.S. Pat. No. 4,341,327 to Zeitz issued Jul. 27, 1982 entitled “Digital proportional metering pumping system” discloses a controlled variable speed pumping system for controlling the operation of one or more independently driven pump motors that includes one or more valveless rotary pumps each having a reciprocating piston directly driven by an individual stepping motor and a digital control circuit for individually directing the operation of each stepping motor whereby the resultant sum output of the pumps may be utilized for mixing, blending or proportioning fluid flow.

U.S. Pat. No. 4,493,286 to Carson issued Jan. 15, 1985 entitled “Method and apparatus for applying a multi-component adhesive” discloses an apparatus and method for applying a multi-component liquid adhesive. A liquid resin reservoir and a liquid hardener reservoir are connected by separate conduit means to resin and hardener mix chamber which is positioned adjacent to a dispenser so that the adhesive can be spread at substantially the same time as it is mixed. Separate resin and hardener pumps are each driven by their own variable output capacity power sources and means are provided for sensing the instantaneous speed of these pumps. These sensors are connected to separate control means for the power sources so that the power output to both of the pumps will be proportional to their respective instantaneous speeds. This apparatus compensates for temperature induced changes in viscosity of the resin or hardener so as to allow mixing proportions to remain constant. Also disclosed is a means for increasing or decreasing the total amount of adhesive produced without having to reset the resin and hardener mix and a means for forcing water or air into the mix chamber in the event of an unanticipated stoppage of the system so as to prevent hardening of the mixture in the mix chamber and dispenser.

U.S. Pat. No. 4,509,903 to Fram issued Apr. 9, 1985 entitled “Catalyst slave pump” discloses a slave pump having a piston rod having a fluid passage through which catalyst is discharged for ultimate use. The slave pump also has an exterior casing which holds it together without contacting the catalyst or other fluids being pumped. A novel combination of a slave pump as just described driven by a master pump having a cylinder and a piston rod, a slave pump having a cylinder and a piston rod, a first means interconnecting the piston rod of the master pump with the piston rod of the slave pump, and a second means connecting the cylinder of the master pump with the cylinder of the slave pump. The position of the slave pump can be adjusted with respect to the master pump to change the amount of catalyst or other fluid delivered by said slave pump per stroke of the slave pump piston. The interconnecting linkages are provided with spherical connections to mitigate wear and binding due to misalignment.

U.S. Pat. No. 4,714,545 to Bente, et al. issued Dec. 22, 1987 entitled “Fluid proportioning pump system” discloses a plurality of different liquid solutions connected to an input of a pump system having at least two displacement chambers and in a manner to control the proportions of each constituent that are taken into each chamber during its intake stroke. The outputs of the chambers are connected to a common liquid output. The chambers are driven by independently controllable motors so that the discharge stroke may be chosen to have some parameters, such as speed profile and duration, that are different than during the intake stroke. As a result, both chambers may simultaneously discharge liquid through the common output, if desired. The proportion of constituents may be made different each time one of the chambers is filled, so the simultaneous discharge of the chambers allows a gradual, carefully controlled change from the mixture of one chamber to that of the other. Thus, the pump system can be operated to provide a combination of low pressure and high pressure mixing of two or more liquid constituents in order to provide a smooth gradient in the output liquid flow. Output liquid flow rate can be controlled by changing the time in which the chamber's volume is reduced, or by controlling the maximum volume of the chamber's displacement, or both. Such a pumping system is especially useful in providing a solvent mixture with a gradually changing composition to a liquid chromatograph column.

U.S. Pat. No. 4,789,100 to Senf issued Dec. 6, 1988 entitled “Multiple fluid pumping system” discloses an apparatus for mixing and dispensing multiple fluids that utilizes two fluid reservoirs each in fluid communication with a respective pump for pumping the fluids to a mixing head, the pumps being mechanically connected to each other and adapted to pump fluids from the reservoirs at a predetermined volume ratio, and with a pressure switch provided for measuring fluid pressure to the mixing head and stopping the pumping of fluid at a predetermined maximum pressure while starting the pumping of fluid when the fluid pressure falls below the predetermined maximum pressure. A device for detecting an empty fluid reservoir is used to stop the pumping of fluids to avoid single component pumping. A mechanical torque-releasable coupling is used to disconnect a pump from the pump drive in the event of an internal pump overload.

U.S. Pat. No. 4,809,909 to Kukesh issued Mar. 7, 1989 entitled “Plural component application system” discloses an apparatus and method for manufacturing plural component materials, especially rigid urethane structures, from reactive components. The system includes a source of a first component, a source of a second component, a sprayer for mixing the components and for dispensing the mixture therefrom, and a delivery system for delivering the components to the sprayer. The delivery system is designed to continuously recirculate the components from their respective sources to the sprayer and back to the sources and includes positive displacement piston pumps simultaneously driven by a single motor. The system further includes means for calibrating the rates of flow of the components in the delivery system and a chopper to direct reinforcing glass fibers into the component mixture dispensed from the sprayer.

U.S. Pat. No. 4,928,880 to Prus, et al. issued May 29, 1990 entitled “Pumped coating product spraying installation” discloses an installation for spraying a coating product in liquid form, as in the automobile industry, that comprises at least one circuit and, in that circuit, a pump, at least one sprayer, and a flexible conduit connecting an outlet of the pump to the sprayer. The flowrate of liquid in the conduit is controlled by a servo-system which controls the pump. The pump is preferably a gear pump.

U.S. Pat. No. 4,998,672 to Bordaz, et al. issued Mar. 12, 1991 entitled “Manually controlled spraying installation and sprayer” discloses an installation for spraying a coating product includes a manually controlled pneumatic sprayer operated by a trigger. The compressed air flowrate is varied according to the position of the trigger. The coating product feed system can include a gear pump driven at variable speed by a motor controlled by an electric signal representing the position of the trigger.

U.S. Pat. No. 5,005,765 to Kistner issued Apr. 9, 1991 entitled “Method and apparatus for applying multicomponent materials” discloses a method and apparatus for metering and pumping multicomponents of high and low viscosity materials and subsequently mixing and applying the mixture includes gear pumps for pumping each component. Each gear pump has gears operating in a gear housing for receiving and pumping one of the components. The gear pumps are simultaneously driven at a predetermined speed and each gear pump is designed to pump a predetermined amount of its respective components, at the predetermined speed. Flexible hoses connect the pumps to an applicator. Check valves are used to maintain the pressure in these hoses when the pumps are in their at-rest position. The gear pumps may be driven at the same rotational speed but are designed to pump a predetermined amount of the different materials so that the ratio of materials can be precisely set.

U.S. Pat. No. 5,388,761 to Langeman issued Feb. 14, 1995 entitled “Plural component delivery system” discloses an apparatus and method for mixing and delivering plural liquid components in a selected volume ratio. For each component, a separate motor drives a separate rotary gear pump that delivers the component to a common mixing and delivery device (spray gun). The speed of each motor, and correspondingly the volume of fluid delivered by that pump, is determined by a respective programmable computer. The individual computers are interlinked, with one master computer and the rest slave(s). Desired motor speeds are input into the computers in a selected ratio. A change in the speed of the master motor therefore produces a corresponding change in the speed of a slave motor according to the ratio. Actual motor speed is monitored and transmitted to the respective computer for feedback control. A manual ratio test is provided for calibration of the system. Each pump is magnetically coupled to its respective motor drive shaft.

U.S. Pat. No. 5,431,343 to Kubiak, et al. issued Jul. 11, 1995 entitled “Fiber jet nozzle for dispensing viscous adhesives” discloses a nozzle for use with an adhesive spray apparatus that includes a nozzle having an extended tip and an air cap having a diverging air passage terminating at an outlet concentric about the tip end. An adhesive outlet at the tip end is extended beyond the air outlet. Channels for swirling the air in the cap about the nozzle are provided in the cap around the nozzle. Highly viscous adhesives are sprayed in a uniform pattern without adhesive accumulation on the nozzle and disruption of pattern.

U.S. Pat. No. 5,486,676 to Aleshin issued Jan. 23, 1996 entitled “Coaxial single point powder feed nozzle” discloses a coaxial single point powder feed nozzle that includes an inner tube disposed coaxially within an outer tube. The inner tube has a powder inlet and powder outlet, and the outer tube has a gas inlet for receiving a shaping gas, and a single nozzle outlet. An intermediate portion of the outer tube is spaced radially outwardly from the inner tube to define an annular flow manifold therebetween which receives the shaping gas. The powder outlet is disposed coaxially with the nozzle outlet and is spaced therefrom to define an annular gas outlet for the manifold for channeling the shaping gas around the powder prior to discharge thereof from the nozzle outlet.

U.S. Pat. No. 5,810,254 to Kropfield issued Sep. 22, 1998 entitled “Low pressure polyurethane spraying assembly” discloses a low pressure spraying assembly for mixing and initiating the reaction of a first liquid reactive polymeric material, such as an isocyanate terminated compound, with a second liquid reactive polymeric material, such as an hydroxyl terminated compound or polyol resin, to form a two part polymer, such as polyurethane, and spraying the polymer onto a surface. The spraying assembly includes a material circulating system and a spray gun assembly. The material circulating system comprises separate multiple diaphragm pumps, drive assemblies, flow meters and feedback controllers for each material. The spray gun assembly includes a manifold with a pair of fluid ports for receiving the first and second polymeric materials. A mixing device is mounted to the manifold for mixing the materials to form the two part polymer. A spray tip with an air cap is mounted to the distal end of the mixing device for spraying the polymeric material. The air cap includes both a main outlet port for dispensing the polymer and atomizing outlet ports for atomizing the polymer. The spray gun assembly also includes an air purging operation for simultaneously removing any polymeric materials from the main outlet port and the atomizing outlet ports, thereby preventing any clogging of the atomizing outlet ports.

U.S. Pat. No. 6,062,492 to Tudor, et al. issued May 16, 2000 entitled “Viscous material dispense system” discloses a viscous material dispense system including a dispense valve having an outlet, a mix tube secured at an upper end thereof to the outlet of the dispense valve, a mixer shroud positioned telescopically over the mix tube and including a conical lower end, and an air shroud fitted telescopically over the lower end of the mixer shroud and defining a conical surface positioned in confronting relation to the conical tip portion of the mixer shroud. The air shroud and the lower end of the mixer shroud coact to define a plurality of circumferentially spaced axially extending flutes extending downwardly between the outer surface of the mixer shroud and the inner surface of the air shroud and a plurality of circumferentially spaced radially extending flutes defined between the conical tip portion of the mixer shroud and the conical surface of the air shroud. Each radial flute communicates with a respective axial flute so that air enters proximate the upper end of the air shroud, moves downwardly between the air shroud and the mixer shroud as a series of axially spaced air streams, and thereafter moves radially inwardly between the lower end of the mixer shroud and the air shroud as a plurality of radially inwardly moving air streams which impinge upon a material bead exiting from the lower end of the mix tube to impart a swirling movement to the bead.

U.S. Pat. No. 6,082,637 to Ludwig issued Jul. 4, 2000 entitled “Nozzle device” discloses a nozzle device including an axially extending tubular, cylindrical outside part; and a cap threaded on the outside part at the front or discharge end of the device and having a discharge bore composed of a rearward cylindrical portion having a first diameter; a frontal cylindrical portion having a second diameter less than the first diameter; and a frustoconical portion connecting the rearward and frontal cylindrical portions with one another. An axially extending inside part is coaxially received in the outside part and has an outer wall defining, with the inner wall of the outside part, an annular space for guiding gas therethrough. The annular space is axially adjoined by the discharge bore of the cap. The inside part further has a forwardly conically tapering end portion projecting into the frontal cylindrical portion of the discharge bore of the cap; an axial bore for guiding a viscous material therethrough; and a nozzle bore axially adjoining the axial bore and having an outlet opening for discharging the viscous material. The nozzle bore outlet opening is situated within the frontal cylindrical portion of the discharge bore of the cap. A port is provided in the outside part for introducing the gas into the annular space. At least three support lugs are positioned in the annular space in engagement with the inner wall of the outside part and the outer wall of the inside part for coaxially positioning the inside part relative to the outside part.

U.S. Pat. No. 6,131,823 to Langeman issued on Oct. 17, 2000 entitled “Low pressure dispensing gun” discloses a dispensing gun for atomizing a fluid under pressure with pressurized air includes a body having two fluid inlet structures and an air inlet structure defined in the body. An elongate barrel housing projects outwardly from the body. A longitudinal air passageway communicating with the air inlet structure and a longitudinal fluid passageway communicating with the fluid inlet structure are defined within the barrel housing. An atomizing structure for atomizing the fluid under pressure with the air under pressure is connected to the distal end of the barrel housing.

U.S. Pat. No. 6,250,567 to Lewis, et al. issued on Jun. 26, 2001 entitled “Apparatus and method for spraying single or multi-component material” discloses an apparatus and method for delivering single or multi-component material through a disposable delivery tube and atomizing the material into a spray pattern of substantially uniform dispersion. The apparatus includes a tubular manifold having an opening for receiving a disposable delivery tube with the exit end or nozzle of the delivery tube projecting out from the end of the manifold. A plurality of atomizer holes is formed in the end of the manifold surrounding the hole which receives the nozzle end of the delivery tube. A source of air under pressure is connected to direct air through the atomizer holes. An air cap is mounted to the manifold to direct air passing through the atomizer holes about the nozzle of the delivery tube to atomize the delivered material into a uniform spray pattern without the material coming into contact with either the manifold or the air cap.

U.S. Pat. No. 6,409,098 to Lewis, et al. issued on Jun. 25, 2002 entitled “Apparatus and method for spraying single or multi-component material” discloses an apparatus and method for delivering single or multi-component material through a disposable delivery tube and atomizing the material into a spray pattern of substantially uniform dispersion. The apparatus includes a tubular manifold having an opening for receiving a disposable delivery tube with the exit end or nozzle of the delivery tube projecting out from the end of the manifold. A plurality of atomizer holes are formed in the end of the manifold surrounding the hole which receives the nozzle end of the delivery tube. A source of air under pressure is connected to direct air through the atomizer holes. An air cap is mounted to the manifold to direct air passing through the atomizer holes about the nozzle of the delivery tube to atomize the delivered material into a uniform spray pattern without the material coming into contact with either the manifold or the air cap.

U.S. Pat. No. 6,601,733 to Schnacky, et al. issued on Aug. 5, 2003 entitled “Multi-component proportioning system and delivery system utilizing same” discloses a multi-component proportioning system for dispensing a multi-component coating composition is provided. The delivery system is intended for use in providing multi-component compositions to a multi-component dispenser. The system provides accurate mix ratios due to the consistent, reproducible displacement of components from the liquid pump assemblies used in the multi-component proportioning system regardless of viscosity. Such accuracy eliminates improper mixing of components that can lead to reworking and lost time, materials, and profits.

U.S. Pat. No. 6,601,782 to Sandholm, et al. issued on Aug. 5, 2003 entitled “Disposable spray nozzle assembly” discloses a disposable synthetic resin spray nozzle assembly for spraying reactive multi-component liquid mixtures includes a static mixer and an air or gas manifold. The static mixer has an elongated mixing tube containing a mixing element, and a liquid dispensing nozzle is formed at the downstream end of the mixing tube. A one-piece manifold has an inner wall which includes a mixer support section sealingly mounted around the static mixer, an air inlet section for receiving an air supply through a conduit, and an air dispensing section which, together with the outer wall of the liquid dispensing nozzle, forms an air dispensing nozzle. The reactive liquid mixture is atomized by air that supplied through the air dispensing nozzle.

U.S. Pat. No. 6,755,348 to Langeman issued Jun. 29, 2004 entitled “Third stream automotive color injection” discloses a method and system for dispensing a colored polymerizing composition. Two reactive components and one color component are pumped from respective containers at a metered volume. The color component, which is preferably a low-viscosity automotive paint is injected into either the first or second stream of reactive component at a point immediately prior to mixing all components in a dispensing device for dispensing the resulting colored fluid mixture onto a surface to be coated. The mixture may be dispensed by pouring or spraying onto the surface.

Despite the foregoing broad range of solutions to deliver fluid/viscous components, all generally suffer from several salient deficiencies, including most notably the lack of a completely disposable “static mixer” or comparable mixing or dispensing assembly, and associated manifold, which are also adapted to provide consistent performance in terms of spray effluent. In a related fashion, these prior art solutions are further not optimized in terms of cost, clean up and set up time in that (i) they are not disposable, and hence cannot be thrown away but rather must be cleaned; and (ii) they require an appreciable degree of adjustment of the components in order to produce a desired spray pattern, due in large part to the variability of the possible positions of the components of the mixer/manifold, especially in relation to one another (such as when assembled at different times by different individuals).

### SUMMARY OF THE INVENTION

The present invention satisfies the aforementioned needs by providing improved apparatus and methods for dispensing fluids and/or viscous materials.

In a first aspect of the present invention, a material dispensing assembly is disclosed. In one embodiment, this apparatus contains a disposable static mixer, a disposable manifold and a disposable atomizer cap. The static mixer and the manifold have engagement features which accurately position an aperture of the atomizer cap relative to the dispensing tip of the static mixer, thereby allowing for precise and repeatable spraying results as well as the aforementioned disposability.

In a second embodiment, the apparatus comprises: a disposable static mixer; a disposable tubular manifold; and a disposable atomizer cap, wherein the static mixer and the tubular manifold has apparatus adapted to locate a front face of the atomizer cap a predetermined distance from a dispensing tip of the static mixer.

In one variant, the apparatus adapted to locate comprises a plurality of tabs formed on the mixer, the tabs configured to engage corresponding ones of grooves within the manifold. The atomizer cap is mated to the manifold in a threaded relationship, the threaded relationship and the apparatus adapted to locate cooperating to place the front face at the predetermined distance.

In yet another variant, the manifold comprises a plurality of apertures disposed around a manifold central aperture, the central aperture adapted to receive at least a portion of the static mixer therethrough. The cap comprises a cap central aperture, the cap central aperture adapted to receive at least a portion of the static mixer therethrough.

In another variant, the static mixer comprises a first section having a first diameter, a second section having a second diameter less than the first diameter, and a third section having a third diameter that is less than the first and second diameters, the second section being disposed between the first and third sections. The at least portion of the static mixer received through the manifold central aperture comprises the second section; and the at least portion of the static mixer received through the cap central aperture comprises the third section.

In another embodiment, the apparatus for dispensing fluidic materials comprises: a substantially polymeric static mixer; a substantially polymeric manifold; and a substantially polymeric atomizer cap mated to the manifold; wherein the static mixer and the manifold are adapted to cooperate to allow the manifold to be repeatedly placed in a substantially identical location with respect to the mixer. In one variant, the static mixer and the manifold comprise a plurality of raised features and corresponding grooves, the raised features and grooves cooperating to align and retain the manifold in a substantially fixed orientation with respect to the mixer. The raised features are disposed on the manifold, and the grooves are disposed on or within the static mixer, or vice-versa, or combinations thereof.

In another variant, the substantially polymeric mixer, manifold and atomizer cap are formed from polyethylene, and configured to be disposed of after one use (e.g., to be changed out with another substantially identical apparatus for dispensing fluidic materials when the fluidic materials are to be changed).

In another variant, the static mixer comprises a first section having a first diameter, a second section having a second diameter less than the first diameter, and a third section having a third diameter that is less than the first and second diameters, the second section being disposed between the first and third sections; the manifold comprises a plurality of apertures disposed around a manifold central aperture, the central aperture adapted to receive at least a portion of the static mixer therethrough; the cap comprises a cap central aperture, the cap central aperture adapted to receive at least a portion of the static mixer therethrough; the at least portion of the static mixer received through the manifold central aperture comprises the second section; and the at least portion of the static mixer received through the cap central aperture comprises the third section.

In a second aspect of the invention, spray apparatus is disclosed. In one embodiment, the spray apparatus comprises: apparatus comprising a plurality of substantially fluidic materials to be mixed and dispensed; and a dispensing apparatus comprising: a substantially polymeric static mixer; a substantially polymeric manifold; and a substantially polymeric atomizer cap mated to the manifold. In one variant, the static mixer and the manifold are adapted to cooperate to allow the manifold to be repeatedly placed in a substantially identical location with respect to the mixer.

In another variant, the substantially polymeric mixer, manifold and atomizer cap are configured to be changed out as a unit with another substantially identical apparatus for dispensing fluidic materials when the fluidic materials dispensed by the spray apparatus are to be changed. The static mixer and the manifold comprise a plurality of raised features and corresponding grooves, the raised features and grooves cooperating to align and retain the manifold in a substantially fixed orientation with respect to the mixer.

In a third aspect of the invention, a method of operating a spray system is disclosed. In one embodiment, the method comprises: providing a first plurality of materials to be sprayed; spraying the first plurality of materials through a disposable spray apparatus; providing a second plurality of materials to be sprayed, the second plurality comprising at least one material that is either different from or in addition to any of those of the first plurality; in the system, removing and replacing the disposable spray apparatus with a second substantially similar disposable spray apparatus; and spraying the second plurality of materials through the second disposable spray apparatus.

In one variant, the disposable spray apparatus comprises: a substantially polymeric static mixer; a substantially polymeric manifold; and a substantially polymeric atomizer cap mated to the manifold; and the act of removing comprises: disconnecting a pressurized gas conduit connection from the manifold; and removing the static mixer from a dispensing gun.

In another variant, the disposable spray apparatus comprises: a static mixer; a manifold; and an atomizer cap mated to the manifold; and the act of replacing comprises replacing the disposable spray apparatus as a unit without further adjustment to any components thereof before initiating the act of spraying the second plurality of materials.

In still another variant, the act of spraying the first plurality of materials through a disposable spray apparatus comprises: mixing the plurality of materials through a mixer tube in order to produce a mixed material; atomizing at least a portion of the mixed material using air introduced via a manifold cooperating with the mixer tube, the atomizing comprising flowing the air around the periphery of a dispensing tip of the mixer tube and simultaneously through an aperture formed in a cap proximate the manifold and the tip.

In a fourth aspect of the invention, a method of assembling a spray dispenser assembly is disclosed. In one embodiment, the method comprises: providing a mixing tube; providing a manifold, the manifold having: first features adapted to cooperate with second features of the mixing tube to allow for removable mating of the tube and the manifold; and a spray cap removably engaged to the manifold; disposing at least a portion of the mixing tube within the manifold; and engaging the first and second features to mate the tube to the manifold; wherein the act of engaging causes a portion of the mixing tube to be disposed in a predetermined location relative to the manifold.

In one variant, the act of disposing comprises inserting the at least portion of the mixing tube into the manifold until no further inward travel is possible; and the act of engaging comprises rotating the manifold with respect to the mixing tube through an angular displacement. The engaging comprises engaging to cause a portion of the tube to be disposed at a predetermined vertical height relative to an atomizing edge of the spray cap.

In a fifth aspect of the invention, a method doing business is disclosed. In one embodiment, the business relates to spraying materials, and the method comprises: spraying a first plurality of materials through a disposable spray apparatus installed in a sprayer system; in the system, removing and replacing the disposable spray apparatus with a second substantially similar disposable spray apparatus; and spraying a second plurality of materials through the second disposable spray apparatus, the second plurality of materials comprising at least one material that is either different from or in addition to any of those of the first plurality.

In one variant of the method, the disposable spray apparatus comprises: a static mixer; a manifold; and an atomizer cap mated to the manifold; and the act of replacing comprises replacing the disposable spray apparatus as a unit without further adjustment to any components thereof before initiating the act of spraying the second plurality of materials. At least one of the acts of spraying comprises spraying the first or second plurality of materials to form a rapid-drying automotive or truck bed liner.

In a sixth aspect of the invention, manifold apparatus useful for the atomization of dispensed fluidic materials is disclosed. In one embodiment, the apparatus comprises: a disposable manifold element adapted to receive at least a distal dispensing portion of a disposable mixing tube therein; and a disposable atomizer cap threadably engaged to the manifold element, wherein the mixing tube and the disposable manifold element each have apparatus adapted to cooperate to allow repeatable locating of a front face of the atomizer cap at a predetermined distance from the distal dispensing tip when the manifold element and mixing tube are assembled and/or reassembled.

### BRIEF DESCRIPTION OF THE DRAWINGS

The features, objectives, and advantages of the invention will become more apparent from the detailed description set forth below when taken in conjunction with the drawings, wherein:

FIG. 1 is a perspective view of a portion of a prior art spray apparatus illustrating the dispensing of reactive chemical components.

FIG. 1a is a cross-sectional view of a prior art air cap assembly illustrating the static mixer, inside of the tubular manifold, and air cap thereof.

FIG. 1b is an exploded perspective view of a prior art material delivery (static mixer) tube and spray nozzle assembly including a tubular manifold and atomizer air cap.

FIG. 1c is a prior art view representation of the circular spray pattern illustrating the symmetrical shape and substantially uniform size and shape of the spray droplets provided by the system of FIGS. 1-1b.

FIG. 2 is an exploded perspective view of one exemplary embodiment of the material dispensing assembly of the present invention.

FIG. 2a is a cross-sectional view of the static mixer of FIG. 2, taken along line 2a-2a.

FIG. 3 is a cross-sectional view of a tubular manifold according to the principles of the present invention.

FIG. 4a is a cross-sectional view of a manifold/mixer assembly according to the principles of the present invention, utilizing the static mixer of FIG. 2 and the tubular manifold of FIG. 3.

FIG. 4b is a cross-sectional view of the manifold/mixer assembly shown in FIG. 4a with an atomizer cap installed onto the tubular manifold according to the principles of the present invention.

FIG. 5a is a detail cross-sectional view of the seating mechanism of the manifold/mixer assembly of FIGS. 4a and 4b.

FIG. 5b is an end view of the static mixer of FIG. 2 according to the principles of the present invention.

FIG. 5c is an end view of the tubular manifold of FIG. 3 according to the principles of the present invention.

FIG. 6 is a logical flow chart of one exemplary embodiment of the method of assembly of the material dispensing assembly of FIG. 2.

### DETAILED DESCRIPTION OF THE INVENTION

Reference is now made to the drawings wherein like numerals refer to like parts throughout.

As used herein, the term “reactive mixture” refers to any multi-component reactive mixture where each individual component, when mixed, result in a chemical reaction whereby the substantially liquid individual components harden into a substantially solid state after a relatively brief period of time. Examples of reactive components used to form a mixture include, without limitation, isocyanate and polyol, which when combined form a mixture that reacts into a substantially solid polyurethane coating.

As used herein, the term “dispensing” refers to any sort of release or provision of one or more materials to a desired location. Dispensing may comprise, without limitation and for example only, spraying (atomized or airless), pouring, and spatter-coating.

Overview

In one salient aspect, the present invention provides an improved dispensing apparatus for use in, inter alia, plural-component coating applications. The present invention seeks to overcome the limitations and deficiencies of the prior art, particularly those relating to the component cost, clean up and set up time for the static mixer/tubular manifold assembly at the end of a spray gun apparatus.

As discussed in greater detail subsequently herein, these deficiencies are overcome by providing a system for dispensing reactive components that is manufactured using low cost materials and methods (thereby making them disposable if desired) as well as simplifying the design in order to aid assembly. For example, in one exemplary configuration, the (i) tubular manifold; and (ii) atomizer air cap are both manufactured from injection molded plastics.

In addition, the various features of the present invention also greatly speed the manifold change-over process, allowing for rapid swapping out of the spray assembly without any need for cleanup, as the static mixer, tubular manifold, and atomizer cap are all made from low cost-disposable plastics that can simply be thrown away without any need to be cleaned.

Also provided by the present invention is a great degree of precision in the adjustment of material flow from the assembly.

Tubular Manifold—Static Mixer Assembly

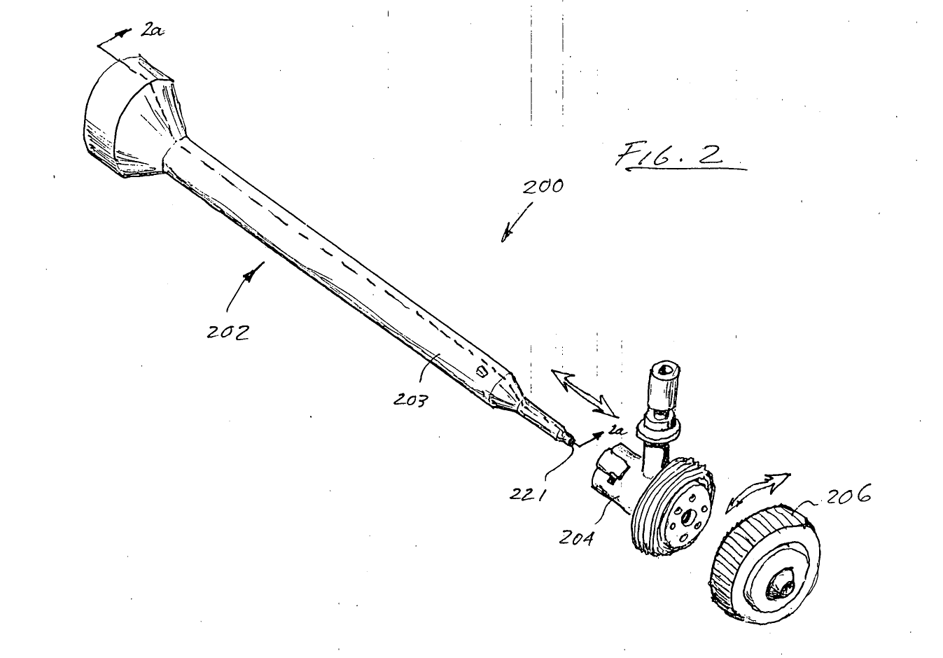

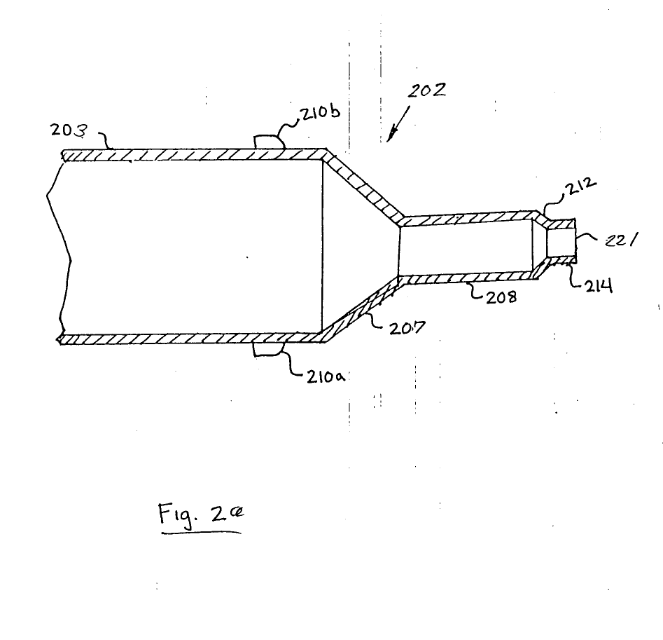

Referring now to FIGS. 2-2a, one exemplary embodiment of the dispenser assembly according to the invention is described. As shown in FIG. 2, the assembly 200 comprises a static mixer 202, tubular manifold assembly 204, and atomizer cap 206. These components are, in the illustrated embodiment, all made from a low-cost polymer and hence disposable if desired, although this is not a requirement.

The static mixer 202 comprises a one-piece static mixer tube 203 with various tube segments 208, 214 of the type generally known in the art, such as e.g., that disclosed in co-owned U.S. Pat. No. 6,409,098 to Lewis, et al, incorporated herein by reference in its entirety (see also U.S. Pat. No. 6,250,567 to Lewis, et al incorporated herein by reference in its entirety). However, distinctions between the static mixer of the illustrated embodiment of FIGS. 2-2a over such other static mixers relates to, inter alia, the design features that improve assembly of the static mixer 202 with the tubular manifold 204. In particular, the locating lugs or tabs 210a, 210b are useful in accurately positioning and securing the static mixer within the tubular manifold 204, as well as maintaining a uniform relationship between the components each time it is re-assembled (even with different components). These positioning features will be described in greater detail subsequently herein with regards to the overall manifold-mixer assembly.

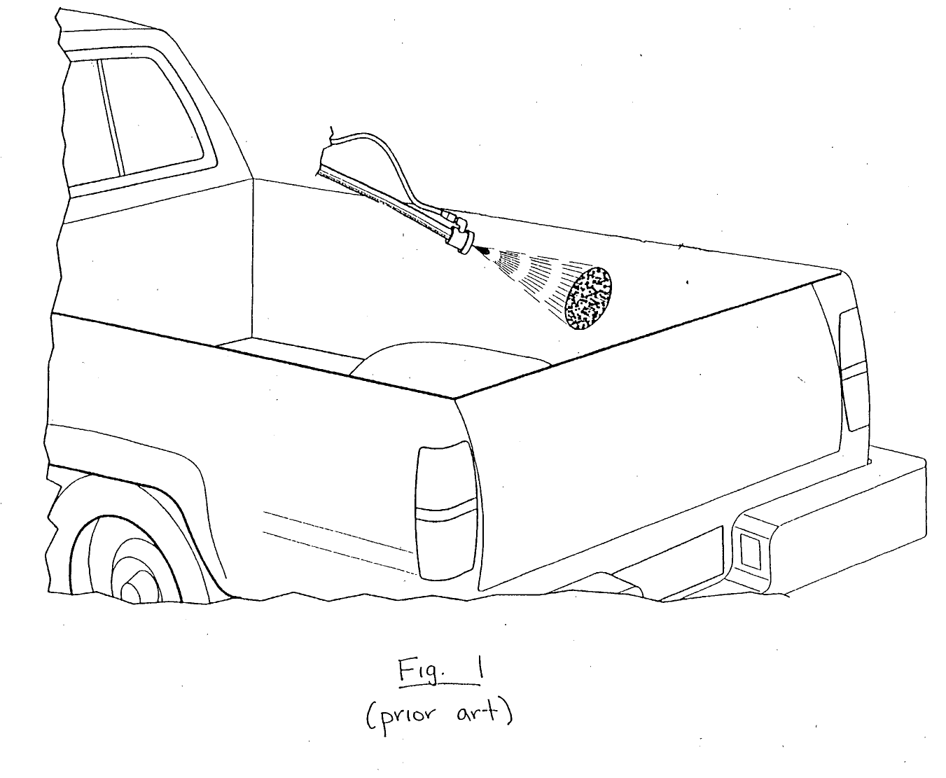

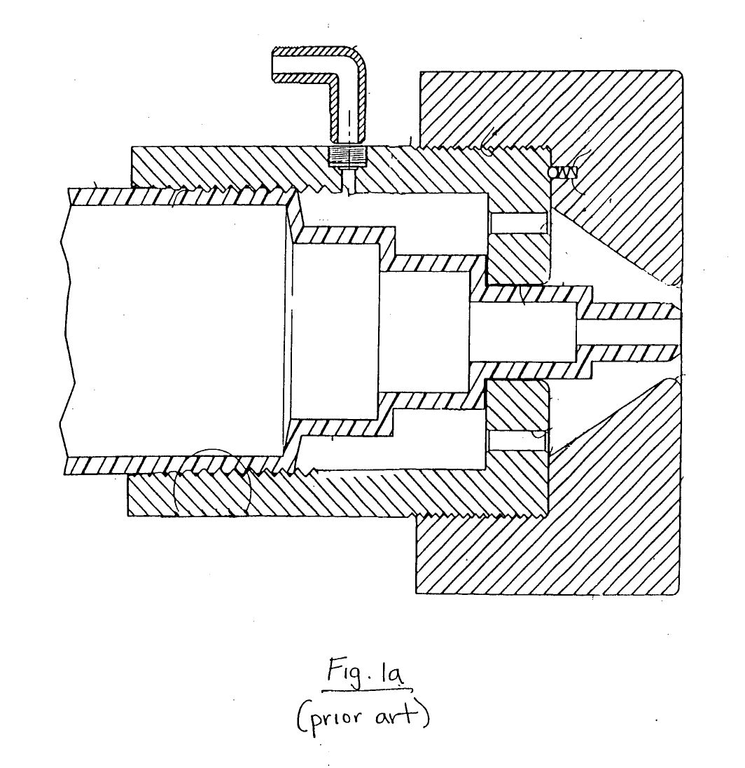

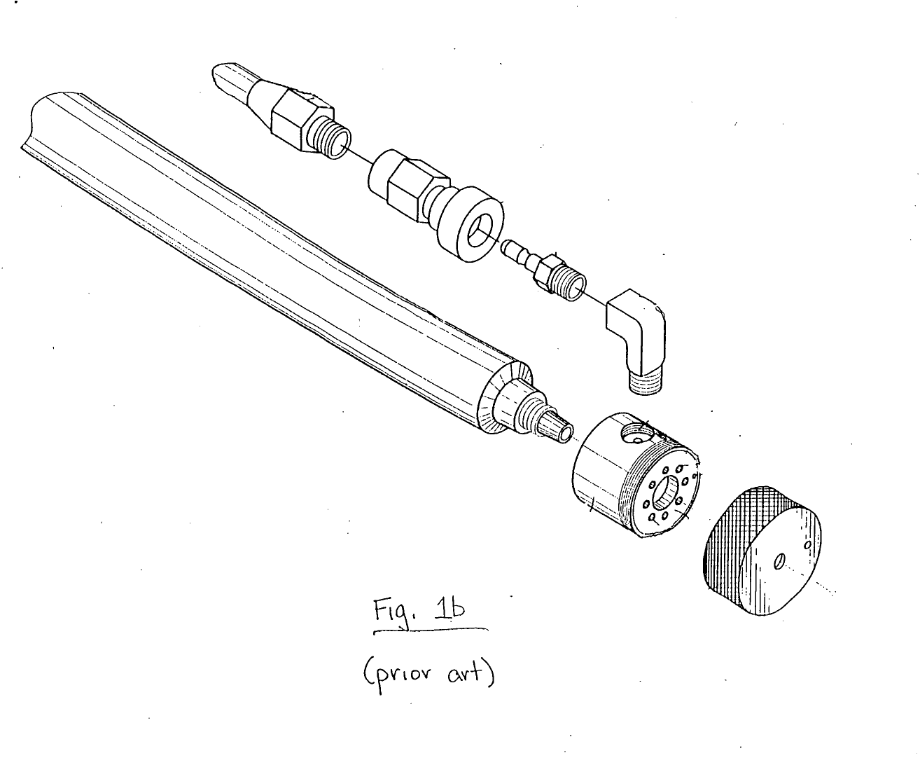

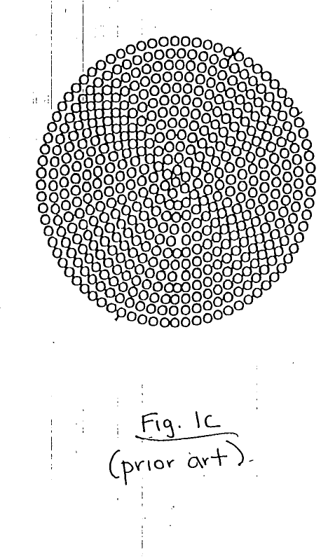

Further, it is also noted that the static mixer 202 of the illustrated embodiment only uses two angled step downs 207, 212 in the diameter of the tube between the various segments 203, 208, 214. Prior art static mixers, such as that shown in FIGS. 1a and 1b, typically used “squared off” step downs in diameter in order to, inter alia, help position the static mixer within a manifold (shown best in FIG. 1a). However, the current embodiment of the present invention has no need to utilize these features as the locating tabs 210 perform the positioning function of these prior stepped features. This not only increases the laminarity or smoothness of the flow of air over these surfaces (as well as the fluidic material on the inside of the tube 203), but also simplifies the molds required to form the tube 203.

It will also be recognized that the mechanism by which “static mixing” occurs need not necessarily be that as shown in the illustrated embodiment (i.e., a substantially cylindrical tube with a fluted mixer insert). Literally any configuration of mixer could be used, so long as the features described herein relating to the distal end of the tube 203 and the manifold are preserved.

Referring now to FIG. 3, one exemplary embodiment of the tubular manifold 204 of FIG. 2 is described in detail. One salient distinction of the tubular manifold 204 of the present embodiment over the prior art is the incorporation of a manifold body 350 with a pressurized air stem 316. This unitary construction has its advantages of reducing overall component count of the tubular manifold of prior art methods (such as that shown in FIG. 1b herein). This also reduces the assembly/labor burden on the user and opportunities for leakage, since fewer pieces must be connected to one another or assembled.

In addition, the tubular manifold 204 of the present invention can be readily manufactured using common injection molding methods that are well understood in the arts. The plastic that is utilized is often a polyethylene or a polypropylene material; however other thermoplastic or thermoset choices may be appropriate depending on the particular user's application. The advantages of different choices in material are well understood in the arts and as such will not be discussed any further herein. Regardless of the material chosen, fabrication costs of the illustrated embodiment of the manifold 204 as compared to the prior art are significantly lower.

The interior wall 318 of the exemplary tubular manifold 204 is designed so that a close or sliding frictional fit occurs between the interior wall 318 of the tubular manifold 204 and the exterior wall 205 of the static mixer tube 203. This is necessary to ensure a proper seal is made when the two items are assembled to prevent excess leakage of pressurized air during operation.

It is noted, however, that under an alternative embodiment, it is not be necessary to ensure a tight geometric fit between the interior wall 318 and exterior wall of the static mixer tube, if an O-ring, gasket (not shown) or other sealing arrangement is utilized between the static mixer 202 and the tubular manifold 204. This alternative arrangement may be useful in increasing molding yields and/or tooling costs associated with “looser” tolerances between components. However, it has been found that current molding techniques (e.g., injection molding) have made the embodiment shown in FIG. 3 economical in terms of both its component manufacturing considerations as well as reducing overall assembly complexity while still providing the required level of performance.

The pressurized air stem 316 also incorporates an air line stop 306 and a catch 302 that allows for the insertion of an air line over the air stem 316, yet is useful in preventing the air line from disengaging the air stem 316 when the manifold is fully pressurized. The external threads 308 interface with the opposing threads 410 of the atomizer air cap 206. Further, similar to other prior art tubular manifold designs, the tubular manifold of the illustrated incorporates a plurality of atomizer apertures (holes) 312 which are ideally positioned symmetrically around the static mixer opening 314, although other numbers and geometries of aperture may be used. The front face 310 of the manifold can advantageously be used as a reference surface so that when the atomizer cap 206 is threaded onto the tubular manifold 204, the atomizer cap 206 is accurately positioned with the static mixer 202 in both the transverse (radial) and longitudinal dimensions.

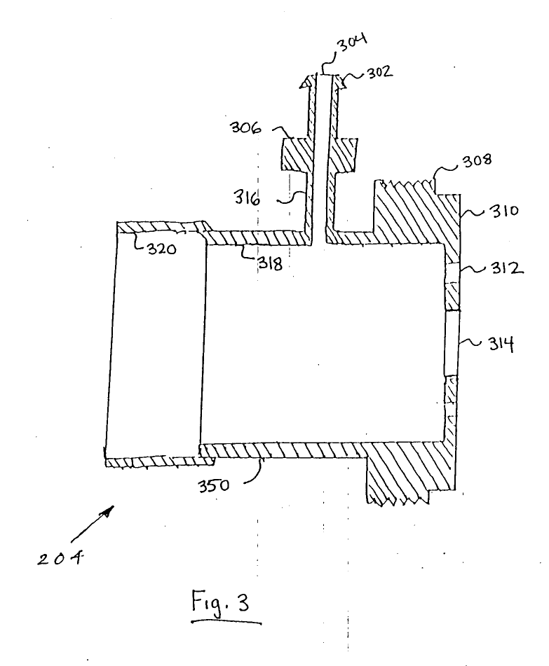

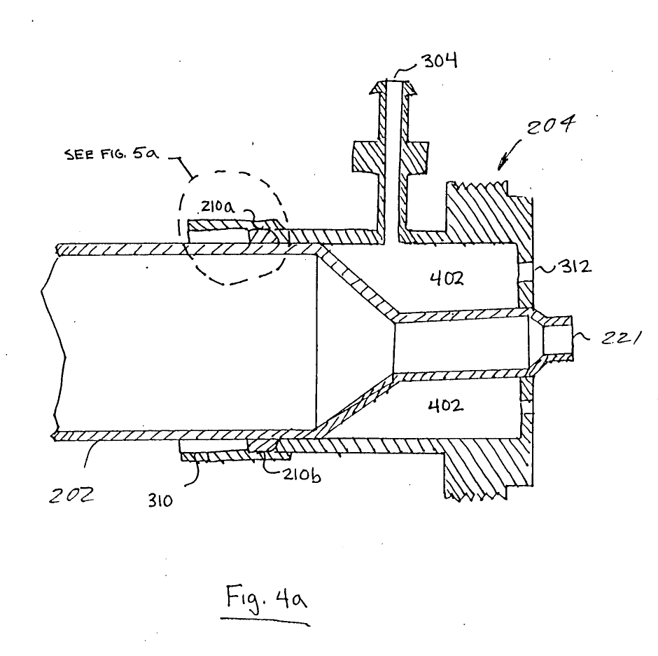

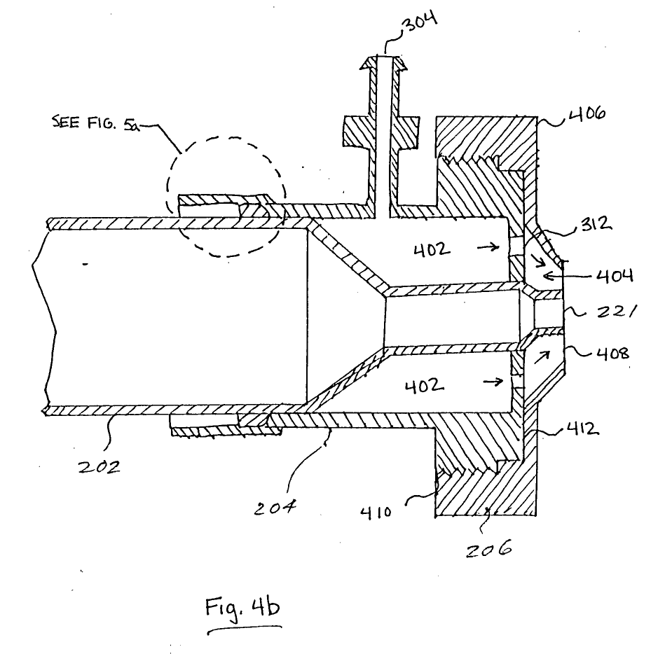

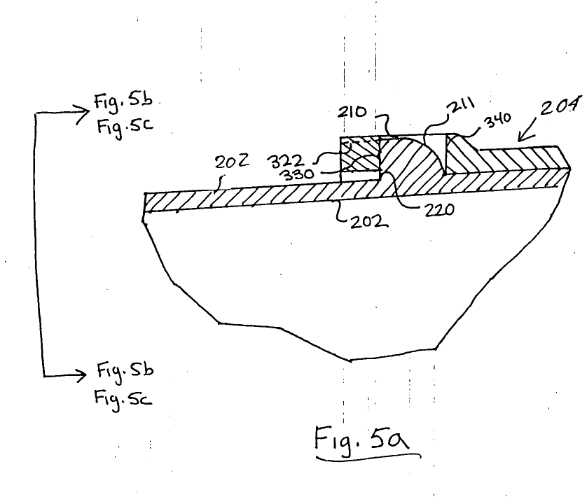

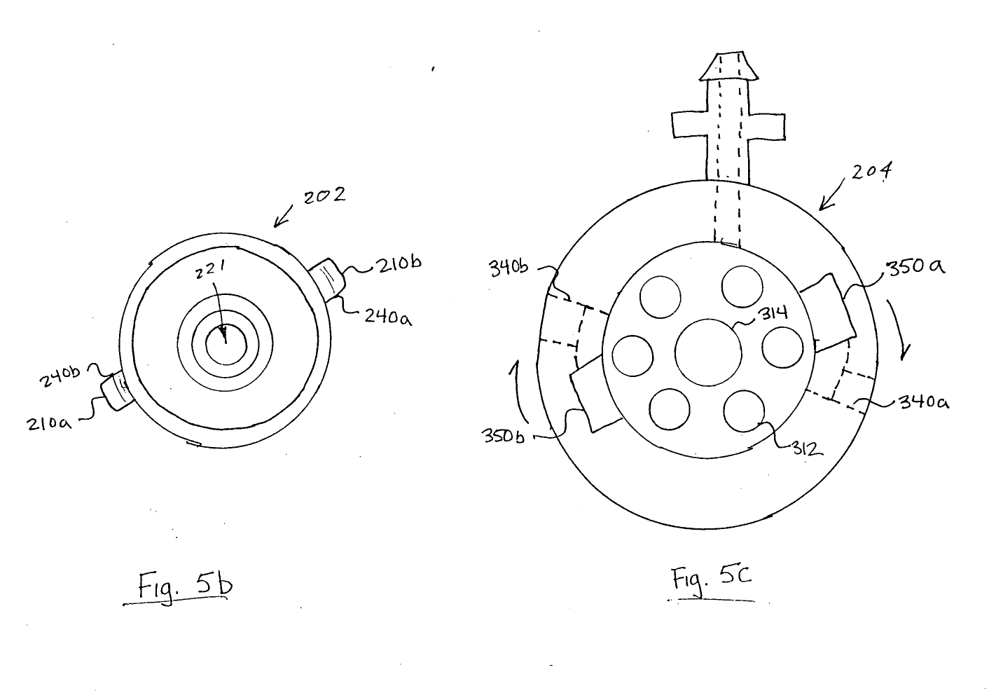

Referring again to the aforesaid positioning features of the present embodiment, the outer diameter of locating tabs 210 are guided via the inside surface 310 of the tubular manifold 204 as the static mixer 202 is inserted into the manifold, as shown in FIGS. 4a and 4b. As best shown in FIG. 5a, once inserted, the locating tabs 210 are constrained by back tubular manifold wall 330 and front tubular manifold wall 340. This accurately positions the static mixer 202 longitudinally with the tubular manifold 204 within a few thousandths of an inch. Optional filleting 211 helps guide the locating tabs into their respective manifold slots 350. As described in greater detail below, this overcomes a significant deficiency present in some prior art systems; i.e., inconsistent placement of the static mixer relative to the manifold, thereby causing inconsistent or unpredictable spray performance due to the varying placement.

As best shown in FIGS. 5b and 5c, locating tabs 210a, 210b are inserted into respective manifold slots 350a, 350b. Once fully inserted, the static mixer 202 (or alternatively the tubular manifold 204) may be rotated into the pocket formed by walls 330 and 340 (see FIG. 5a). During this rotation, locating tab walls 240a, 240b eventually come to rest against internal manifold walls 340a, 340b. It is after this rotation that the static mixer 202 becomes constrained in the longitudinal and radial degrees of freedom, and the two assembled components cannot be separated without rotating the components relative to one another in the opposite direction.

One salient advantage of the aforementioned approach of constraining the static mixer 202 in the longitudinal and radial directions with respect to the manifold 204 (and hence the cap 206 when the latter is fully threaded on or attached) is that the relationships between the dispensing tip 221 of the static mixer tube and the dispensing aperture in the cap 206 are predetermined and not variable to any significant degree (other than when the cap is variably threaded, as described below). Prior art approaches to disposable static mixer and manifold assemblies did not maintain this substantially fixed relationship, and hence the user would need to set the proper position by “trial and error”, which leads to wasted time, material, and less precise results. Conversely, the illustrated embodiment of the present invention allows for precise relationships to be established quickly each and every time, thereby obviating the trial-and-error.

Furthermore, by using a threaded cap 206 in the illustrated embodiment, some degree of variability in the longitudinal relationship of the cap aperture and the dispensing tip 221 is afforded if desired. If so, the user merely rotates the cap 206 to the desired position on the threads of the manifold 204. If not, the user merely threads the cap 206 onto the threads until snug, thereby establishing the aforementioned predetermined relationship in position. Hence, the illustrated embodiment provides the best of both worlds, in that both easy setup of a predetermined relationship is provided, yet variability of this relationship is also available if desired.

Furthermore, although the exemplary embodiment shows threads 308 as the fastening mechanism between the tubular manifold 204 and the atomizer cap 206 (see FIGS. 4a and 4b), other methods and techniques (such as e.g., a “snap on” cap 206) would be readily apparent to one of ordinary skill; accordingly, threads are in no way required to practice the invention.

Once the static mixer 202 is inserted inside of the tubular manifold 204, a cavity volume 402 is formed between the two components. This cavity volume 402 fills with pressurized air that is received via the opening 304 of the pressurized air stem 316. Subsequently, the pressurized air in cavity 402 is released from the tubular manifold 204 through the atomizer holes 312 and into the cavity 404 formed between the atomizer cap 206 and the tubular manifold 204. The pressurized air is directed past the dispensing end 221 of the static mixer 202, atomizing the reactive components into small droplets resulting in a uniform dispersion of the reactive mixture (such as in the prior art pattern shown in FIG. 1c).

Furthermore, when used in conjunction with the invention disclosed in co-owned and co-pending U.S. patent application Ser. No. 11/173,868 entitled “APPARATUS AND METHODS FOR DISPENSING FLUIDIC OR VISCOUS MATERIALS” filed Jul. 1, 2005 and incorporated herein by reference in its entirety, nearly all components within a reactive component dispensing system that might come into contact with reactive components are made disposable, or impermeable to atmospheric moisture, etc., thereby substantially obviating the need to use any solvents in between spray applications necessary in other prior art systems. For example, in one exemplary combination, the aforesaid system would utilize disposable reagent or material dispensing bags and lines, “piggyback” pumps (which themselves can be made optionally disposable), static mixer 202, manifold 204, cap 206, and manifold supply lines, so that little if any cleanup is required, and material color changes can be effected rapidly as well.

Method of Assembly and Use

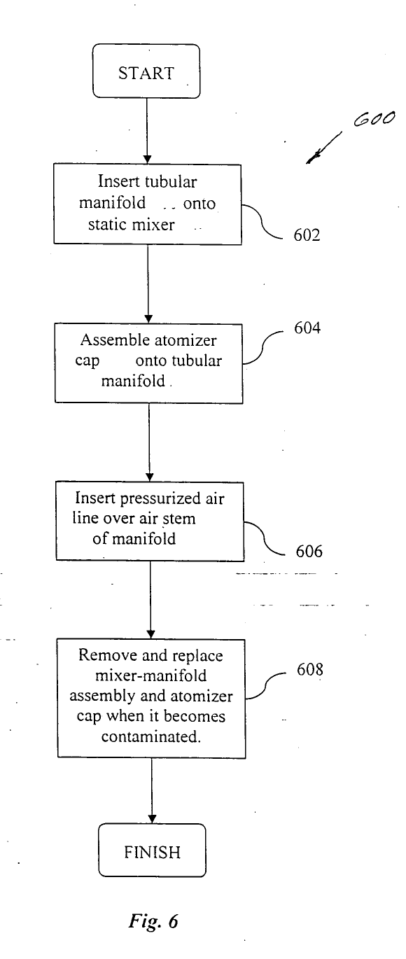

Referring now to FIG. 6, one exemplary embodiment of the method of operating the apparatus of the invention is disclosed. It will be appreciated that while the following method 600 is described in the context of one exemplary procedure for changing the manifold-mixer assembly of a polyurethane coating spray apparatus, the method is more broadly applicable to any kind of sprayed reactive material (e.g., from one resin type to another, etc.), in addition to changing colors between a polyurethane coating, etc.

For purposes of illustration, the method 600 of FIG. 6 assumes that the static mixer 202 has already been assembled onto a prior art spray gun apparatus, such as that utilized in U.S. Pat. No. 6,250,567 issued to Lewis et al. In addition, it is assumed that a pressurized line is available that is adapted to fit onto the pressurized air stem 316 of the present invention. In the first step 602 of the present method, the disposable tubular manifold 204 is inserted over the static mixer 202 as previously described above. Once, the manifold 204 has been fully seated, the manifold 204 is rotated to lock the manifold 204 onto the static mixer 202 in the longitudinal direction. Note also that the sliding frictional fit between the outside surfaces of the static mixer tube 203 and the inside diameter 318 of the manifold 204 restricts the movement of the assembly in the non-longitudinal degrees of freedom.

In step 604, the atomizer cap 206 is threaded onto the tubular manifold threads 308 until the inside wall 412 of the cap is seated against the front wall 310 of the manifold 204. This positions the front opening 408 on substantially the same plane as the dispensing tip opening 221 of the static mixer 204. While other configurations are contemplated, this particular configuration works well in the application of polyurethane coatings.

In step 606, a pressurized air line is inserted over the air line stem 316 of the manifold 204. The leading edge of the pressurized air line is inserted fully until it is seated against air line stop 306. In addition, the catch 302 of the air line stem 316 partially embeds itself into the wall of the pressurized air line, thus preventing the air line from disengaging from the air line stem 316 during operation of the apparatus.

In step 608, after use of the spray apparatus, if the mixer-manifold assembly becomes contaminated with the polyurethane coating, the entire assembly 200 including the static mixer 202, manifold 204, and atomizer cap 206 may be removed from the spray gun and disposed of. These components can then be replaced as previously described.

In addition to the application of polyurethane to surfaces such as truck beds and mine conveyor belts, it is appreciated that the present apparatus is applicable to the dispensing of numerous different kinds of materials. Materials that can be sprayed in accordance with the principles of the present invention (with proper adaptation of the equipment) include, without limitation, paints, glues or adhesives, stucco, mastics, sealants, foams, undercoating, and other types of coatings, as well as other types of polymer based formulations that contain more than one component.

Methods of Doing Business

As previously noted, the disposable mixer-manifold assembly is particularly useful when used in conjunction with a disposable static mixer. This approach also advantageously relieves the business (e.g., manufacturing and inventory) facilities producing and stocking these devices from the burden of producing and stocking varying different components; rather a low cost and “universal” manifold and “universal” atomizer cap can be provided to readily change out contaminated manifolds and caps without the need to use costly cleaning procedures or solutions/chemicals. In addition, since these components in many cases can be manufactured from a single or limited number of tools, the consistency between the physical dimensions of the components can be exploited offering more consistent polyurethane application results between differing components.

It will be recognized that while certain aspects of the invention are described in terms of a specific sequence of steps of a method, these descriptions are only illustrative of the broader methods of the invention, and may be modified as required by the particular application. Certain steps may be rendered unnecessary or optional under certain circumstances. Additionally, certain steps or functionality may be added to the disclosed embodiments, or the order of performance of two or more steps permuted. All such variations are considered to be encompassed within the invention disclosed and claimed herein.

While the above detailed description has shown, described, and pointed out novel features of the invention as applied to various embodiments, it will be understood that various omissions, substitutions, and changes in the form and details of the device or process illustrated may be made by those skilled in the art without departing from the invention. The foregoing description is of the best mode presently contemplated of carrying out the invention. This description is in no way meant to be limiting, but rather should be taken as illustrative of the general principles of the invention. The scope of the invention should be determined with reference to the claims.

What is claimed is:

1. Apparatus for dispensing fluidic materials, comprising:
a disposable static mixer;
a disposable tubular manifold; and
a disposable atomizer cap, wherein said static mixer and said tubular manifold has apparatus adapted to locate a front face of said atomizer cap a predetermined distance from a dispensing tip of said static mixer.

2. The apparatus of claim 1, wherein said apparatus adapted to locate comprises a plurality of tabs formed on said mixer, said tabs configured to engage corresponding ones of grooves within said manifold.

3. The apparatus of claim 2, wherein said atomizer cap is mated to said manifold in a threaded relationship, said threaded relationship and said apparatus adapted to locate cooperating to place said front face at said predetermined distance.

4. The apparatus of claim 2, wherein said static mixer comprises a first section having a first diameter, a second section having a second diameter less than said first diameter, and a third section having a third diameter that is less than said first and second diameters, said second section being disposed between said first and third sections.

5. The apparatus of claim 2, wherein said manifold comprises a plurality of apertures disposed around a manifold central aperture, said central aperture adapted to receive at least a portion of said static mixer therethrough.

6. The apparatus of claim 5, wherein said cap comprises a cap central aperture, said cap central aperture adapted to receive at least a portion of said static mixer therethrough.

7. The apparatus of claim 5, wherein said static mixer comprises a first section having a first diameter, a second section having a second diameter less than said first diameter, and a third section having a third diameter that is less than said first and second diameters, said second section being disposed between said first and third sections;
wherein said at least portion of said static mixer received through said manifold central aperture comprises said second section; and
wherein said at least portion of said static mixer received through said cap central aperture comprises said third section.

8. Apparatus for dispensing fluidic materials, comprising:
a substantially polymeric static mixer;
a substantially polymeric manifold; and
a substantially polymeric atomizer cap mated to said manifold;
wherein said static mixer and said manifold are adapted to cooperate to allow said manifold to be repeatedly placed in a substantially identical location with respect to said mixer.

9. The apparatus of claim 8, wherein said static mixer and said manifold comprise a plurality of raised features and corresponding grooves, said raised features and grooves cooperating to align and retain said manifold in a substantially fixed orientation with respect to said mixer.

10. The apparatus of claim 9, wherein said raised features are disposed on said manifold, and said grooves are disposed on or within said static mixer.

11. The apparatus of claim 8, wherein said atomizer cap is mated to said manifold in a threaded relationship, said threaded relationship at least in part determining the position of a front face of said cap with respect to a distal tip of said static mixer.

12. The apparatus of claim 8, wherein said substantially polymeric mixer, manifold and atomizer cap are formed from polyethylene, and configured to be disposed of after one use.

13. The apparatus of claim 8, wherein said substantially polymeric mixer, manifold and atomizer cap are formed from polyethylene, and configured to be changed out with another substantially identical apparatus for dispensing fluidic materials when said fluidic materials are to be changed.

14. The apparatus of claim 13, wherein:
said static mixer comprises a first section having a first diameter, a second section having a second diameter less than said first diameter, and a third section having a third diameter that is less than said first and second diameters, said second section being disposed between said first and third sections;
said manifold comprises a plurality of apertures disposed around a manifold central aperture, said central aperture adapted to receive at least a portion of said static mixer therethrough;
said cap comprises a cap central aperture, said cap central aperture adapted to receive at least a portion of said static mixer therethrough;
said at least portion of said static mixer received through said manifold central aperture comprises said second section; and
said at least portion of said static mixer received through said cap central aperture comprises said third section.

15. Spray apparatus, comprising:
apparatus comprising a plurality of substantially fluidic materials to be mixed and dispensed; and
a dispensing apparatus comprising:
a substantially polymeric static mixer;
a substantially polymeric manifold; and
a substantially polymeric atomizer cap mated to said manifold.

16. The spray apparatus of claim 15, wherein said static mixer and said manifold are adapted to cooperate to allow said manifold to be repeatedly placed in a substantially identical location with respect to said mixer.

17. The spray apparatus of claim 15, wherein said substantially polymeric mixer, manifold and atomizer cap are configured to be changed out as a unit with another substantially identical apparatus for dispensing fluidic materials when said fluidic materials dispensed by said spray apparatus are to be changed.

18. The spray apparatus of claim 17, wherein said static mixer and said manifold comprise a plurality of raised features and corresponding grooves, said raised features and grooves cooperating to align and retain said manifold in a substantially fixed orientation with respect to said mixer.

19. A method of operating a spray system, comprising:
providing a first plurality of materials to be sprayed;
spraying said first plurality of materials through a disposable spray apparatus;
providing a second plurality of materials to be sprayed, said second plurality comprising at least one material that is either different from or in addition to any of those of said first plurality;
in said system, removing and replacing said disposable spray apparatus with a second substantially similar disposable spray apparatus; and
spraying said second plurality of materials through said second disposable spray apparatus.

20. The method of claim 19, wherein said disposable spray apparatus comprises:
a substantially polymeric static mixer;
a substantially polymeric manifold; and
a substantially polymeric atomizer cap mated to said manifold; and
said act of removing comprises:
disconnecting a pressurized gas conduit connection from said manifold; and
removing said static mixer from a dispensing gun.

21. The method of claim 19, wherein said disposable spray apparatus comprises:
a static mixer;
a manifold; and
an atomizer cap mated to said manifold; and
said act of replacing comprises replacing said disposable spray apparatus as a unit without further adjustment to any components thereof before initiating said act of spraying said second plurality of materials.

22. The method of claim 19, wherein said act of spraying said first plurality of materials through a disposable spray apparatus comprises:
mixing said plurality of materials through a mixer tube in order to produce a mixed material;
atomizing at least a portion of said mixed material using air introduced via a manifold cooperating with said mixer tube, said atomizing comprising flowing said air around the periphery of a dispensing tip of said mixer tube and simultaneously through an aperture formed in a cap proximate said manifold and said tip.

23. A method of assembling a spray dispenser assembly, the method comprising:
providing a mixing tube;
providing a manifold, said manifold having:
first features adapted to cooperate with second features of said mixing tube to allow for removable mating of said tube and said manifold; and
a spray cap removably engaged to said manifold;
disposing at least a portion of said mixing tube within said manifold; and
engaging said first and second features to mate said tube to said manifold;
wherein said act of engaging causes a portion of said mixing tube to be disposed in a predetermined location relative to said manifold.

24. The method of claim 23, wherein said act of disposing comprises inserting said at least portion of said mixing tube into said manifold until no further inward travel is possible; and said act of engaging comprises rotating said manifold with respect to said mixing tube through an angular displacement.

25. The method of claim 23, wherein said engaging comprises engaging to cause a portion of said tube to be disposed at a predetermined vertical height relative to an atomizing edge of said spray cap.

26. A method doing business, said business relating to spraying materials, comprising:
spraying a first plurality of materials through a disposable spray apparatus installed in a sprayer system;
in said system, removing and replacing said disposable spray apparatus with a second substantially similar disposable spray apparatus; and
spraying a second plurality of materials through said second disposable spray apparatus, said second plurality of materials comprising at least one material that is either different from or in addition to any of those of said first plurality.

27. The method of claim 26, wherein said disposable spray apparatus comprises:
a static mixer;
a manifold; and
an atomizer cap mated to said manifold; and
said act of replacing comprises replacing said disposable spray apparatus as a unit without further adjustment to any components thereof before initiating said act of spraying said second plurality of materials.

28. The method of claim 27, wherein at least one of said acts of spraying comprises spraying said first or second plurality of materials to form a rapid-drying automotive or truck bed liner.

29. Manifold apparatus useful for the atomization of dispensed fluidic materials, comprising:
a disposable manifold element adapted to receive at least a distal dispensing portion of a disposable mixing tube therein; and
a disposable atomizer cap threadably engaged to said manifold element, wherein said mixing tube and said disposable manifold element each have apparatus adapted to cooperate to allow repeatable locating of a front face of said atomizer cap at a predetermined distance from said distal dispensing tip when said manifold element and mixing tube are assembled and/or reassembled.
